(19) United States
(12) Patent Application Publication
(10) Pub. No.: US 2026/0340186 A1
(43) Pub. Date: Oct. 29, 2026

(54) AI-Based Method for Enforcing Data-Security Policies in Communication with AI Agent

(71) Applicant: Hong Kong Applied Science and Technology Research Institute Company Limited, Hong Kong (HK)

(72) Inventors: Peifung Eric LAM, Hong Kong (HK); Zhihua XIAO, Hong Kong (HK); Yu WANG, Hong Kong (HK); Cailing CAI, Hong Kong (HK); Wei Lun Alan CHEUNG, Hong Kong (HK); Tao YU, Hong Kong (HK)

(21) Appl. No.: 19/189,211

(22) Filed: Apr. 24, 2025

(51) Int. Cl. G06F 21/62

(52) U.S. Cl. CPC G06F 21/6254; G06F 21/6209

(57) ABSTRACT

The invention provides AI-based system and method for enforcing data-security policies during interactions with AI agents. The system includes a domain-specific, security-aware large language model (LLM) and a sensitive data anonymizer module. The LLM detects sensitive data in user prompts, which the anonymizer encrypts and replaces with encrypted placeholders, preserving the prompt's structure before sending it to the AI agent. Upon receiving a response, the system checks for undesirable content. If none is found and the response contains encrypted data, the anonymizer decrypts it to provide the final user-readable response. This ensures secure, policy-compliant communication with AI agents. The invention can ensure compliance with organizational policies while enabling seamless integration into existing LLM systems, thereby mitigating risks associated with data exposure and enhancing the security of LLM-generated responses.

### FIELD OF THE INVENTION

The present invention relates to artificial intelligence (AI) and data security, specifically to a method for protecting user privacy in communication with AI servers or agents.

### BACKGROUND OF THE INVENTION

Generative language model-based AI servers or agents are increasingly utilized across various industries, including sales, marketing, finance, legal, education, and government institutions. Users can interact with the AI agents via natural language prompts, facilitating human-like conversations, generating creative content, and enhancing productivity through problem-solving and task automation. However, AI agents are typically deployed as online services, requiring users to transmit prompts to cloud servers, which may raise confidentiality concerns, particularly when users inadvertently input sensitive business or personal data into prompts, potentially leading to unauthorized data exposure. Additionally, responses generated by AI agents may include undesirable or harmful content that violates corporate policies or regulatory guidelines.

Existing AI agent interaction frameworks lack robust domain-specific mechanisms for detecting and managing sensitive data. In particular, current approaches fail to provide user-configurable taxonomies for sensitive data classification, effective sensitive entity extraction techniques for addressing industry-specific requirements.

Some large language model (LLM)-based solutions have been developed to identify and mitigate exposure of sensitive information using personally identifiable information (PII) recognition algorithms. These approaches may involve explicit tagging, obfuscation, or suppression of detected sensitive information. However, existing PII recognition methods often suffer from limited adaptability and contextual understanding, making them inadequate for addressing evolving privacy concerns and dynamic data protection requirements.

Accordingly, there remains an unmet need for improved techniques to mitigate the risk of sensitive data leakage, enhance the safety of AI agent interaction, and facilitate the seamless integration of sensitive data protection mechanisms into existing LLM frameworks.

### SUMMARY OF THE INVENTION

It is an objective of the present invention to provide a technical solution for enhancing privacy and safety in AI agent interactions by introducing a robust framework for detecting, anonymizing, and safeguarding sensitive information. The solution ensures compliance with organizational policies while enabling seamless integration into existing LLM systems, thereby mitigating risks associated with data exposure and enhancing the security of LLM-generated responses.

In accordance with a first aspect of the present invention, an AI-based system for enforcing data-security policies in communication with an AI agent is provided. The system comprises: a domain-specific security-aware LLM module fine-tuned from a pretrained LLM module; and a sensitive data anonymizer module. The domain-specific security-aware LLM module is configured to: receive a user prompt from a user; and detect sensitive data in the user prompt. If sensitive data is detected in the user prompt: the sensitive data anonymizer module is configured to: encrypt each of the sensitive data to obtain a corresponding encrypted data; replace each of the sensitive data in the user prompt with the corresponding encrypted data to convert the user prompt to a structure-preserving encrypted prompt; and transmit the structure-preserving encrypted prompt to the AI agent. The domain-specific security-aware LLM module is further configured to: receive a response generated by the AI agent in reply to the structure-preserving encrypted prompt; detect undesirable content in the response. If no undesirable content is detected in the response: the sensitive data anonymizer module is configured to: check whether the response contains encrypted data. If the response contains encrypted data: the sensitive data anonymizer module is configured to: decrypt the encrypted data to obtain a decrypted response in reply to the user prompt; and return the decrypted response to the user.

In accordance with a second aspect of the present invention, an AI-based method for enforcing data-security policies in communication with an AI agent is provided. The method comprises: receiving a user prompt from a user; detecting, by a domain-specific security-aware LLM module, sensitive data in the user prompt. If sensitive data is detected in the user prompt, the method further comprises: encrypting, by a sensitive data anonymizer module, each of the sensitive data to obtain a corresponding encrypted data; replacing each of the sensitive data in the user prompt with the corresponding encrypted data to convert the user prompt to a structure-preserving encrypted prompt; transmitting the structure-preserving encrypted prompt to the external AI agent; receiving a response generated by the external AI agent in reply to the structure-preserving encrypted prompt; detecting, by the domain-specific security-aware LLM module, undesirable content in the response. If no undesirable content is detected in the response, the method further comprises: checking whether the response contains encrypted data. If the response contains encrypted data, the method further comprises: decrypting, by the sensitive data anonymizer module, the encrypted data to obtain a decrypted response in reply to the user prompt and returning the decrypted response to the user.

### BRIEF DESCRIPTION OF THE DRAWINGS

Embodiments of the invention are described in more details hereinafter with reference to the drawings, in which:

FIG. 1 shows a flowchart for an AI-based method for enforcing data-security policies on a user in communication with an AI agent in accordance with one embodiment of the present invention.

FIG. 2 shows an AI-based system for enforcing data-security policies on a user in communication with an AI agent in accordance with one embodiment of the present invention.

FIG. 3 shows an example of how data-security policies are enforced on a user in communication with an AI agent.

FIG. 4 shows a flowchart of a method for obtaining the domain-specific security-aware LLM module in accordance with one embodiment of the present invention.

FIG. 5A shows how the AI-based system is used for dynamically customizing domain-specific data-security policy documents and detecting unsafe content in a message based on the customized policy documents in real-time; and FIG. 5B shows examples of message and active policy involved in the dynamic policy customization and unsafe content detection in FIG. 5A.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

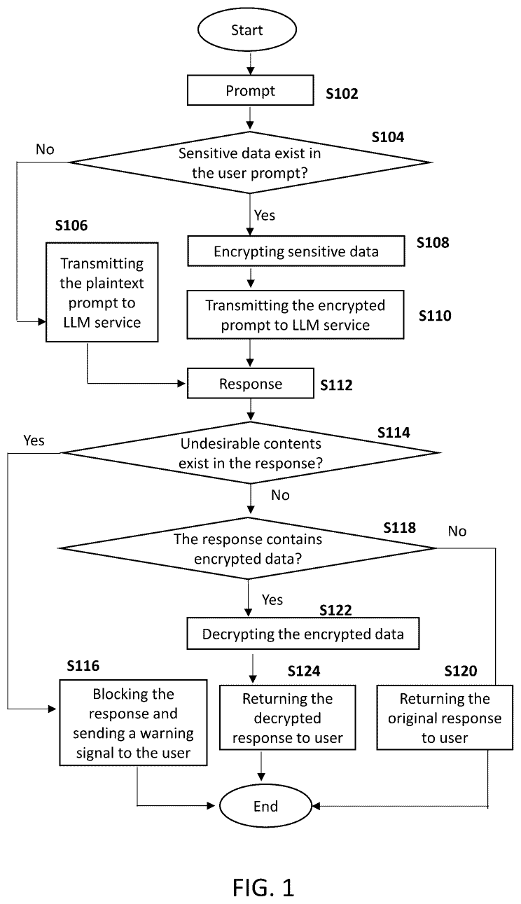

FIG. 1 shows a flowchart for an AI-based method S100 for enforcing data-security policies on a user in communication with an AI agent in accordance with one embodiment of the present invention. The AI-based method comprises the following steps:
S102: receiving a user prompt;
S104: detecting, by a domain-specific security-aware LLM module, sensitive data in the user prompt;

If no sensitive data is detected in the user prompt:
S106: directly transmitting the user prompt to the AI agent; if sensitive data is detected in the user prompt:
S108: encrypting, by a sensitive data anonymizer module, each of the sensitive data to obtain a corresponding encrypted data (or placeholder) and replacing each of the sensitive data in the user prompt with the corresponding encrypted data to convert the user prompt to a structure-preserving encrypted prompt (or format-preserving encrypted prompt);
S110: transmitting the structure-preserving encrypted prompt to the AI agent;
S112: receiving a response generated by the AI agent;
S114: detecting, by the domain-specific security-aware LLM module, undesirable content in the response;

If undesirable content is detected in the response:
S116: blocking the response and sending a warning signal to the user;

If no undesirable content is detected in the response:
S118: checking if the response contains encrypted data;

If the response does not contain encrypted data:
S120: returning the response to the user.

If the response contains encrypted data:
S122: decrypting, by the sensitive data anonymizer module, the encrypted data to obtain a decrypted response in reply to the user prompt;
S124: returning the decrypted response to the user;

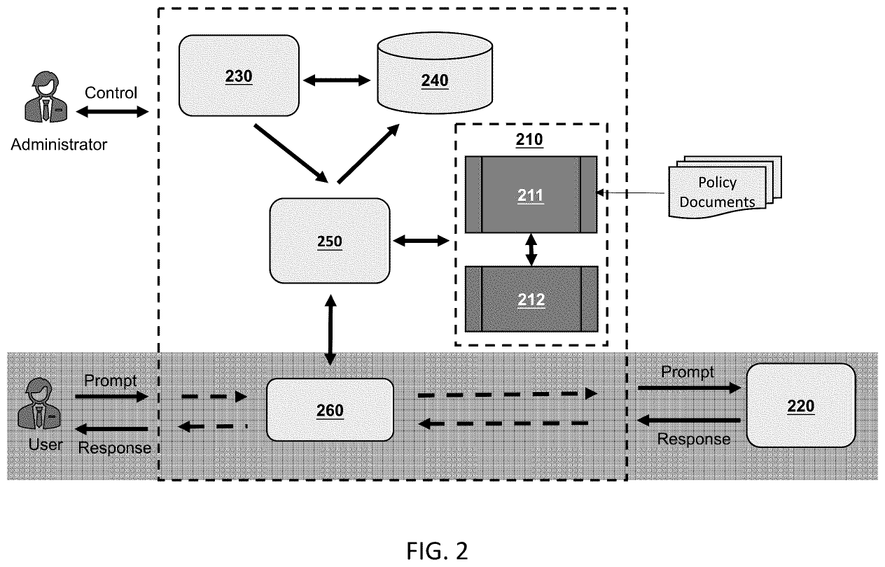

FIG. 2 shows an AI-based system 200 for enforcing data-security policies on a user in communication with an AI agent in accordance with one embodiment of the present invention. The system 200 includes a privacy protection (or access shield) machine 210 comprising a pre-trained LLM module which is fine-tuned to be a domain-specific security-aware LLM module 211 for handling sensitive tasks like confidentiality detection and compliance monitoring; and a sensitive data anonymizer module 212 for anonymizing, masking or blocking sensitive data before being processed or sent to AI agent 220, like Copilot, ChatGPT and Perplexity, to provide advanced AI capabilities for generating responses to user prompts.

The system 200 may further include a user interface (UI) 230 for facilitating an organization administrator to configure and manage the privacy protection system, including setting detection parameters, policies and monitoring system activity; a database 240 for storing detected information, logs, and other essential data for the privacy protection system, ensuring efficient data retrieval and management; an integrator module 250 for managing data flow between different modules, processing data and storing information in the database 240 for subsequent analysis and monitoring so as to ensure seamless integration of components, handling and securing requests and responses and enforcing privacy policies; a proxy module 260 acting as an intermediary layer intercepting and forwarding the information between users and LLM services.

The system 200 may further include one or more processors and a memory in communication with the one or more processors and storing instructions that, when executed by the one or more processors, are configured to cause the system 200 to perform the AI-based method S100 for enforcing data-security policies on a user in communication with an AI agent.

Specifically, the domain-specific security-aware LLM module is configured to: receive a user prompt from a user; analyze the user prompt to determine whether sensitive data is present in the user prompt.

If sensitive data is present in the user prompt, domain-specific security-aware LLM module is further configured to extract the sensitive data from the user prompt and send the extracted sensitive data to the sensitive data anonymizer module via integrator module 250. The sensitive data anonymizer module is configured to: encrypt each of the sensitive data to obtain a corresponding encrypted data; replace each of the sensitive data in the user prompt with the corresponding encrypted data to convert the user prompt to a structure-preserving encrypted prompt; and transmit the structure-preserving encrypted prompt to the AI agent via integrator module 250 and proxy module 260.

The domain-specific security-aware LLM module is further configured to: receive a response generated by the AI agent in reply to the structure-preserving encrypted prompt; and detect undesirable content in the response. If no undesirable content is detected in the response, the sensitive data anonymizer module is configured to check whether the response contains encrypted data. If the response contains encrypted data, the sensitive data anonymizer module is configured to: decrypt the encrypted data to obtain a decrypted response in reply to the user prompt; and return the decrypted response to the user.

Preferably, in the step of S108, each of the sensitive data is encrypted by a format-preserving encryption such that the corresponding encrypted data preserves semantic contextual integrity of the sensitive data. The format-preserving encryption is performed on each sensitive data by:
a) determining a format constraint associated with the sensitive data;
b) generating an encryption key based on a cryptographic key derivation function; and
c) applying a format-preserving encryption algorithm to the sensitive data using the encryption key based on the determined format constraint.

In some embodiments, the format-preserving encryption algorithm is inspired by Feistel networks, such as the FF1 algorithm. For example, a Feistel network may be used as a cryptographic structure for block ciphers. The Feistel network consists of multiple rounds where a cryptographic function is applied to a portion of the sensitive data and combined with the other portion using modular arithmetic. More specifically, the format-preserving Feistel-based encryption algorithm comprises:
a) dividing the sensitive data into first and second halves;
b) using the cryptographic function to compute an output on the first half using the encryption key to obtain a first function output;
c) combining the first function output with the second half using modular arithmetic to obtain a first format-preserving encrypted data;
d) using the cryptographic function to compute an output on the second half using the encryption key to obtain a second function output;
e) combining the second function output with the first half using modular arithmetic to obtain a second format-preserving encrypted data; and
f) repeating steps (b) to (e) for multiple rounds to enhance security;
g) concatenating the first and second format-preserving encrypted data after all rounds have been completed to form a final encrypted data corresponding to the sensitive data.

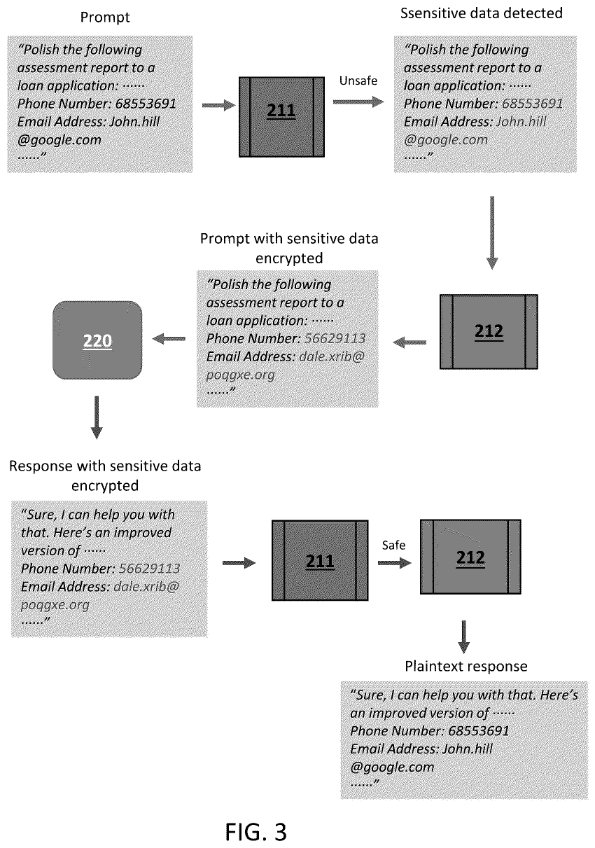

FIG. 3 shows an example of how data-security policies are enforced on a user in communication with an AI agent. When a prompt “Polish the following assessment report to a loan application: . . . Phone Number: 68553691, Email Address: John.hill@google.com” is requested by a user, the phone number “68553691” and email address “John.hill@google.com” are detected as sensitive data by the domain-specific security-aware LLM module 211. The detected phone number “68553691” and email address “John.hill@google.com” are encrypted to “56629113” and “dale.xrib@poqgxe.org” by the sensitive data anonymizer module 212 through a format-preserving encryption algorithm respectively. The prompt with sensitive data encrypted is transmitted to the LLM service 220 to process. When a response is generated by the LLM service 220, the domain-specific security-aware LLM module 211 checks if undesirable contents exist in the response. After the response is determined to be safe, the encrypted data “56629113” and “dale.xrib@poqgxe.org” are decrypted to the sensitive data “68553691” and “John.hill@google.com” by the sensitive data anonymizer module 212 respectively. Finally, a plaintext response with the sensitive data is generated and presented to the user.

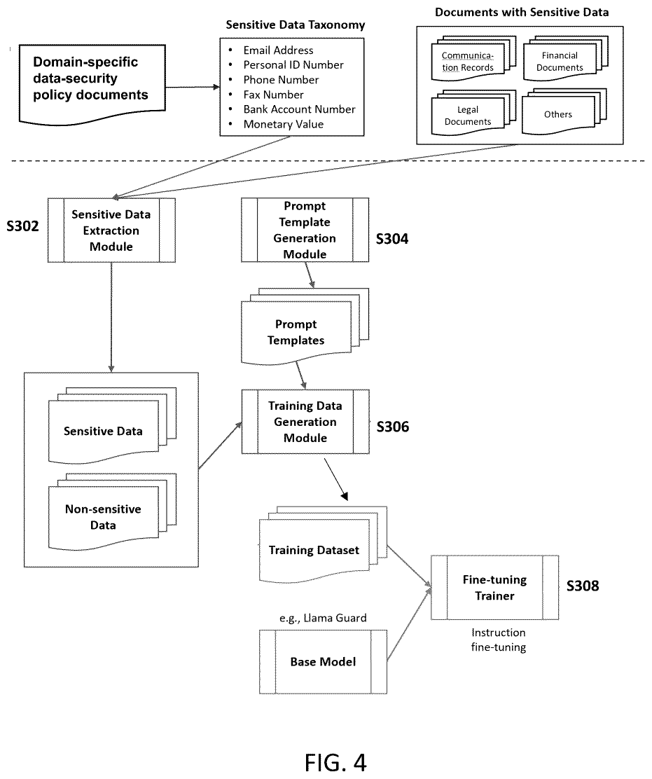

The domain-specific security-aware LLM module 211 may be obtained by fine-tuning a pre-trained LLM with domain-specific data-security policy documents. FIG. 4 shows a flowchart for obtaining the domain-specific security-aware LLM module in accordance with one embodiment of the present invention. As shown, the domain-specific security-aware LLM module is obtained by:
S302: constructing a sensitive data taxonomy based on the domain-specific data-security policy documents; the sensitive data taxonomy may include, but not limited to, categories of email addresses, personal identification numbers, phone numbers, fax numbers, bank account number and monetary value;
S304: generating a collection of prompt templates customized for a collection of scenarios respectively; the collection of scenarios may include, but not limited to, email drafting, document summarization, and data analysis;
S306: extracting sensitive data and non-sensitive data from a set of training documents with sensitive data based on the sensitive data taxonomy and incorporating the extracted sensitive data and extracted non-sensitive data into the generated collection of prompt templates to create an instruction-based training dataset; the set of training documents with sensitive data may include, but not limited to, communication records, financial documents, and legal documents;
S308: fine-tuning the pre-trained language model with the created instruction-based training dataset to obtain the domain-specific security-aware language model.

In some embodiments, the framework 200 may further be used dynamically customizing the domain-specific data-security policy documents and detect unsafe content in a user prompt or LLM response based on the customized policy documents in real-time.

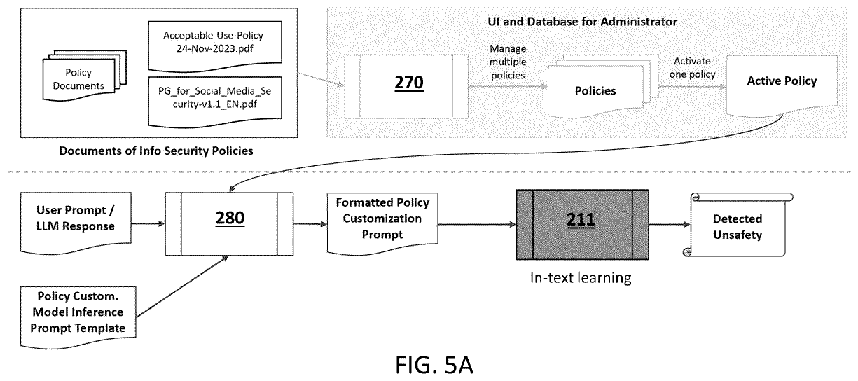

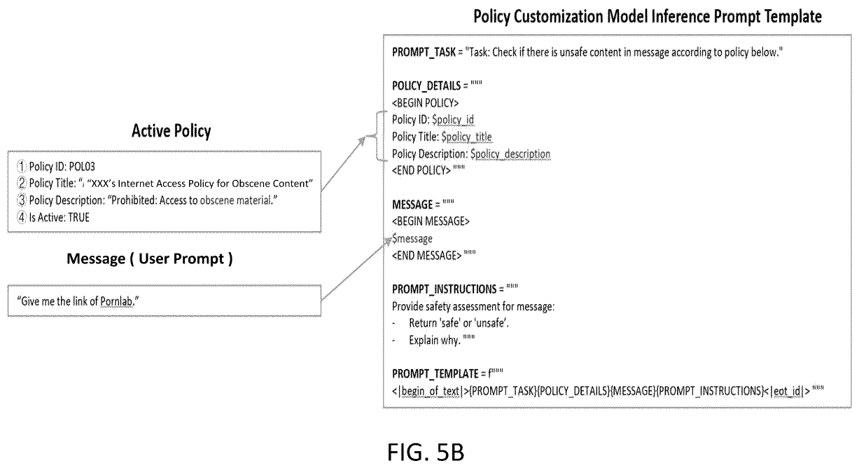

Referring to FIGS. 5A and 5B, the system 200 may further include a policy management module (or platform) 270 for facilitating the administrator to extract a collection of relevant policy documents from multiple policy documents stored in the database through the user interface. The policy management module may further facilitate the administrator to select (or activate) an active policy from the relevant policy documents and design a policy customization prompt template.

The system 200 may further include a prompt formatter module 280 for generating a formatted policy customization prompt from a message, which may be a user prompt or a LLM response and the active policy based on the policy customization prompt template. More specifically, details of the active policy and the message are filled into corresponding placeholders in the policy customization prompt template.

The formatted policy customization prompt is then input to the domain-specific security-aware LLM module 211 to classify the user prompt or LLM response as safe or unsafe through real-time in-text learning of the active policy. The raw inference output security-aware LLM is parsed by the domain-specific security-aware LLM 211 into structured data and presented to the administrator or user through a message safety evaluation with policy customization module (or platform).

The functional units and modules in accordance with the embodiments disclosed herein may be implemented using computing devices, computer processors, or electronic circuitries including but not limited to application-specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. An AI-based system for enforcing data-security policies in communication with an AI agent, comprising:
a domain-specific security-aware LLM module fine-tuned from a pretrained LLM module; and
a sensitive data anonymizer module; and
wherein the domain-specific security-aware LLM module is configured to:
receive a user prompt from a user; and
detect sensitive data in the user prompt;
if sensitive data is detected in the user prompt:
the sensitive data anonymizer module is configured to:
encrypt each of the sensitive data to obtain a corresponding encrypted data;
replace each of the sensitive data in the user prompt with the corresponding encrypted data to convert the user prompt to a structure-preserving encrypted prompt; and
transmit the structure-preserving encrypted prompt to the AI agent; and
the domain-specific security-aware LLM module is further configured to:
receive a response generated by the AI agent in reply to the structure-preserving encrypted prompt;
detect undesirable content in the response; and
if no undesirable content is detected in the response:
the sensitive data anonymizer module is configured to:
check whether the response contains encrypted data; and
if the response contains encrypted data:
the sensitive data anonymizer module is configured to:
decrypt the encrypted data to obtain a decrypted response in reply to the user prompt; and
return the decrypted response to the user.

2. The AI-based system according to claim 1, wherein the privacy protection machine is further configured to directly transmit the user prompt to the AI agent if no sensitive data is detected in the user prompt.

3. The AI-based system according to claim 1, wherein the privacy protection machine is further configured to block the response and sending a warning signal to the user if undesirable content is detected in the response.

4. The AI-based system according to claim 1, wherein each of the sensitive data is encrypted with a format-preserving encryption algorithm such that the corresponding encrypted data preserves semantic contextual integrity of the sensitive data.

5. The AI-based system according to claim 4, wherein the format-preserving encryption is performed on each sensitive data by:
determining a format constraint associated with the sensitive data;
generating an encryption key based on a cryptographic key derivation function;
applying a format-preserving encryption algorithm to the sensitive data using the encryption key based on the determined format constraint.

6. The AI-based system according to claim 1, wherein the format-preserving encryption algorithm is format-preserving Feistel-based encryption algorithm.

7. The AI-based system according to claim 1, wherein the domain-specific security-aware LLM module is obtained by fine-tuning a pre-trained LLM with domain-specific data-security policy documents by:
constructing a sensitive data taxonomy based on the domain-specific data-security policy documents;
generating a collection of prompt templates customized for a collection of scenarios respectively;
extracting sensitive data and non-sensitive data from a set of training documents based on the sensitive data taxonomy;
incorporating the extracted sensitive data and extracted non-sensitive data into the generated collection of prompt templates to create an instruction-based training dataset; and
training the pre-trained language model with the created instruction-based training dataset to obtain the domain-specific security-aware language model.

8. The AI-based system according to claim 1, further comprising a policy management module and a prompt formatter module;
wherein the policy management module is configured to: extract a collection of relevant policy documents from multiple policy documents; and select an active policy from the extracted relevant policy documents;
wherein the prompt formatter module is configured to: generate a formatted policy customization prompt from a received message and the selected active policy based on a policy customization prompt template; and input the formatted policy customization prompt to the domain-specific security-aware LLM module; and
wherein the domain-specific security-aware LLM module is further configured to classify the received message as safe or unsafe through real-time in-text learning of the active policy and generate an inference output.

9. The AI-based system according to claim 8, wherein the formatted policy customization prompt is generated by filling the received message and details of the active policy into corresponding placeholders in the policy customization prompt template.

10. The AI-based system according to claim 8, wherein the policy management module is further configured to:
parse the inference output into structured data; and
present the structured data to the user.

11. An AI-based method for enforcing data-security policies in communication with an AI agent, comprising:
receiving a user prompt from a user;
detecting, by a domain-specific security-aware LLM module, sensitive data in the user prompt; and
if sensitive data is detected in the user prompt:
encrypting, by a sensitive data anonymizer module, each of the sensitive data to obtain a corresponding encrypted data;
replacing each of the sensitive data in the user prompt with the corresponding encrypted data to convert the user prompt to a structure-preserving encrypted prompt;
transmitting the structure-preserving encrypted prompt to the external AI agent;
receiving a response generated by the external AI agent in reply to the structure-preserving encrypted prompt;
detecting, by the domain-specific security-aware LLM module, undesirable content in the response;
if no undesirable content is detected in the response:
checking whether the response contains encrypted data; and
if the response contains encrypted data: decrypting, by the sensitive data anonymizer module, the encrypted data to obtain a decrypted response in reply to the user prompt and returning the decrypted response to the user.

12. The AI-based method according to claim 11, further comprising: if no sensitive data is detected in the user prompt, directly transmitting the user prompt to the AI agent.

13. The AI-based method according to claim 11, further comprising: if undesirable content is detected in the response, blocking the response and sending a warning signal to the user.

14. The AI-based method according to claim 11, wherein each of the sensitive data is encrypted by a format-preserving encryption such that the corresponding encrypted data preserves semantic contextual integrity of the sensitive data.

15. The AI-based method according to claim 14, wherein the format-preserving encryption is performed on each sensitive data by:
determining a format constraint associated with the sensitive data;
generating an encryption key based on a cryptographic key derivation function;
applying a format-preserving encryption algorithm to the sensitive data using the encryption key based on the determined format constraint.

16. The AI-based method according to claim 14, wherein the format-preserving encryption algorithm is format-preserving Feistel-based encryption algorithm.

17. The AI-based method according to claim 11, wherein the domain-specific security-aware LLM module is obtained by fine-tuning a pre-trained LLM with domain-specific data-security policy documents by:
constructing a sensitive data taxonomy based on the domain-specific data-security policy documents;
generating a collection of prompt templates customized for a collection of scenarios respectively;
extracting sensitive data and non-sensitive data from a set of training documents based on the sensitive data taxonomy;
incorporating the extracted sensitive data and extracted non-sensitive data into the generated collection of prompt templates to create an instruction-based training dataset; and
training the pre-trained language model with the created instruction-based training dataset to obtain the domain-specific security-aware language model.

18. The AI-based method according to claim 11, further comprising:
extracting, by a policy management module, a collection of relevant policy documents from multiple policy documents;
selecting, by the policy management module, an active policy from the extracted relevant policy documents;
generating, by a prompt formatter module, a formatted policy customization prompt from a received message and the selected active policy based on a policy customization prompt template;
inputting, by the prompt formatter module, the formatted policy customization prompt to the domain-specific security-aware LLM module;
classifying, by the domain-specific security-aware LLM module, the received message as safe or unsafe through real-time in-text learning of the active policy; and
generating, by the domain-specific security-aware LLM module, an inference output.

19. The AI-based method according to claim 18, wherein the formatted policy customization prompt is generated by filling the received message and details of the active policy into corresponding placeholders in the policy customization prompt template.

20. The AI-based method according to claim 18, wherein further comprising: parsing, by the policy management module, the inference output security-aware LLM into structured data; and presenting, by the policy management module, the structured data to the user.
